(19) United States
(12) Patent Application Publication
(10) Pub. No.: US 2008/0318104 A1
(43) Pub. Date: Dec. 25, 2008

(54) Electrolyte solution for hydrogen generating apparatus and hydrogen generating apparatus comprising the same

(75) Inventors: Bo-Sung Ku, Suwon-si (KR); Jae-Hyuk Jang, Seongnam-si (KR); Kyoung-Soo Chae, Suwon-si (KR); Arunabha Kundu, Suwon-si (KR); Jae-Hyoung Gil, Seoul (KR); Chang-Ryul Jung, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/155,960

(22) Filed: Jun. 12, 2008

(30) Foreign Application Priority Data
Jun. 12, 2007 (KR) 10-2007-0057269

(51) Int. Cl. H01M 8/08

(52) U.S. Cl. 429/29; 429/46

(57) ABSTRACT

The invention provides an electrolyte solution for hydrogen generating apparatus including water; at least one ionizing compound; and at least one chelating agent. The electrolyte solution for hydrogen generating apparatus according to the invention can increase hydrogen generation time and an amount of hydrogen generation by controlling hydrogen generation rate and by reducing an amount of metal hydroxide generation.

### CROSS-REFERENCE TO RELATED APPLICATION

This application claims the benefit of Korean Patent Application No. 10-2007-0057269 filed with the Korean Intellectual Property Office on Jun. 12, 2007, the disclosures of which are incorporated herein by reference in its entirety.

### BACKGROUND OF THE INVENTION

1. Technical Field

The present invention relates to an electrolyte solution for hydrogen generating apparatus and a hydrogen generating apparatus including the electrolyte solution.

2. Description of the Related Art

A fuel cell refers to an energy conversion apparatus that directly converts oxygen in the air and hydrogen (pure hydrogen or hydrogen contained in hydrocarbons such as methanol or natural gas) into electrical energy by an electrochemical reaction.

FIG. 1 illustrates the basic operational principle of a fuel cell. Referring to FIG. 1, a fuel cell 10 may include a fuel electrode 11 as an anode and an air electrode 13 as a cathode. The fuel electrode 11 receives hydrogen molecular (H₂). The hydrogen is dissociated at the fuel electrode to form hydrogen ions (H⁺) and electrons (e⁻).

The hydrogen ions (H⁺) move toward the air electrode 13 via a membrane 12 which is an electrolyte layer. The electrons move through an external circuit 14 to generate an electric current. The hydrogen ions and the electrons are combined with oxygen of the air at the air electrode 13 to generate water. The fuel electrode 11 and the air electrode 13 are disposed in between the electrolyte membrane to form a membrane electrode assembly (MEA).

The following Reaction Scheme 1 explains the above mentioned chemical reactions:

Fuel electrode 11: H₂→2H++2e⁻

Air electrode 13: ½O₂+2H++2e⁻→H₂0

Overall reaction: H₂+½O₂→H₂0 [Reaction Scheme 1]

In short, the fuel cell 10 functions as a battery since the electrons dissociated from the fuel electrode 11 generate current, moving through the external circuit. Such a fuel cell 10 not only is a pollution-free power because it has no noxious emissions such as SOx, NOx, etc., but also produces a small amount of carbon dioxide. Also, the fuel cell device has some advantages, such as low noise and vibration-free and so on.

Fuel cells may be classified, depending on the electrolyte being used, as follows: alkaline fuel cells (AFC); phosphoric acid fuel cells (PAFC); molten carbonate fuel cells (MCFC); and polymer electrolyte membrane fuel cells (PEMFC). Among them, the polymer electrolyte membrane fuel cells can be further classified into proton exchange membrane fuel cells (PEMFC) in which hydrogen gas is directly used as a fuel; and direct methanol fuel cells (DMFC) in which the liquid methanol is directly used as a fuel.

The polymer electrolyte membrane fuel cells can be smaller in size and lighter in weight because of their low operating temperature and high power density, compared to other fuel cells. For these reasons, the polymer electrolyte membrane fuel cells are particularly suitable for use in transportable power supply equipments for vehicles including cars; on-site power supply equipments for in-house or public facilities; and small size power supply units for electronic appliances. Therefore, a great deal of development research is currently under way on the polymer electrolyte membrane fuel cell technologies.

Meanwhile, stable hydrogen production and supply thereof is the most challenging technical problem to be solved so as to commercialize the fuel cells. A hydrogen storage tank, generally known as the hydrogen generating apparatus, has been used to solve these problems. However, the tank apparatus occupies a large space and should be kept with special care.

In order to avoid such drawbacks associated with the known apparatus, fuels such as methanol and formic acid, permitted to be brought into an airplane by International Civil Aviation Organization (ICAO), are reformatted into hydrogen; methanol, ethanol, or formic acid is directly used as a fuel in the fuel cell.

However, the former case requires a high reforming temperature and a complicate system, consumes driving power, and contains impurities (CO₂, CO) besides pure hydrogen molecules. The latter case deteriorates power density due to a low rate of a chemical reaction at the anode and a cross-over of hydrocarbon through the membrane.

Besides, hydrogen generating methods for PEMFC are as follows: oxidation of aluminum, hydrolysis of metal borohydride (BH₄), reaction on a metal electrode and so on. Among them, the preferable method for efficiently controlling a generation rate of hydrogen is by using the metal electrode.

However, a hydrogen gas flow rate rapidly increases and thus causes water inside a reactor to overflow when the reaction on the metal electrode is carried out continuously. Further, a metal hydroxide is produced as a by-product which exists in a slurry state in a reactor due to its low water solubility and may deteriorate the hydrogen generation efficiency.

Accordingly, the present inventors have researched to overcome the above-described problems. As a result, the present inventors develop a new hydrogen generating apparatus which is capable of generating hydrogen by using an ionizing compound and a chelating compound.

### SUMMARY

In one aspect, the present invention provides an electrolyte solution for a hydrogen generating apparatus including water; at least one ionizing compound; and at least one chelating agent.

The ionizing compound is selected from the group consisting of lithium chloride, potassium chloride, sodium chloride, calcium chloride, potassium nitrate, sodium nitrate, potassium sulfate, sodium sulfate, and mixtures thereof.

The ionizing compound has a concentration ranging from about 5 weight % to about 35 weight %.

The chelating agent can be carboxylates, particularly the carboxylates can be selected from the group consisting of potassium citrate, sodium citrate, sodium acetate, potassium acetate, ammonium acetate and mixtures thereof.

The chelating agent has a concentration ranging from about 5 weight % to about 20 weight %.

In another aspect, the present invention can provide a hydrogen generating apparatus including an electrolyzer filled with an electrolyte solution having water, at least one ionizing compound, and at least one chelating agent; a first metal electrode that is disposed in the electrolyzer, is immersed in the electrolyte solution, and generates electrons; and a second metal electrode that is disposed in the electrolyzer, is immersed in the electrolyte solution, and generates hydrogen gas by receiving the electrons.

The hydrogen generating apparatus can be combined with a fuel cell to supply hydrogen to the fuel cell.

At least two of each of the first metal electrode and the second metal electrode can be disposed in the electrolyzer.

Further, the present invention can provide a fuel cell system including the hydrogen generating apparatus according to the invention; and a membrane electrode assembly (MEA) that is provided with hydrogen generated from the hydrogen generating apparatus and produces direct electric current by converting a chemical energy of the hydrogen into an electric energy.

These and other features, aspects, and advantages of the present invention will become better understood with regard to the following description, appended claims, and accompanying drawings or may be learned by practice of the invention.

### BRIEF DESCRIPTION OF THE DRAWINGS

FIG. 1 illustrates the basic operational principle of a fuel cell.

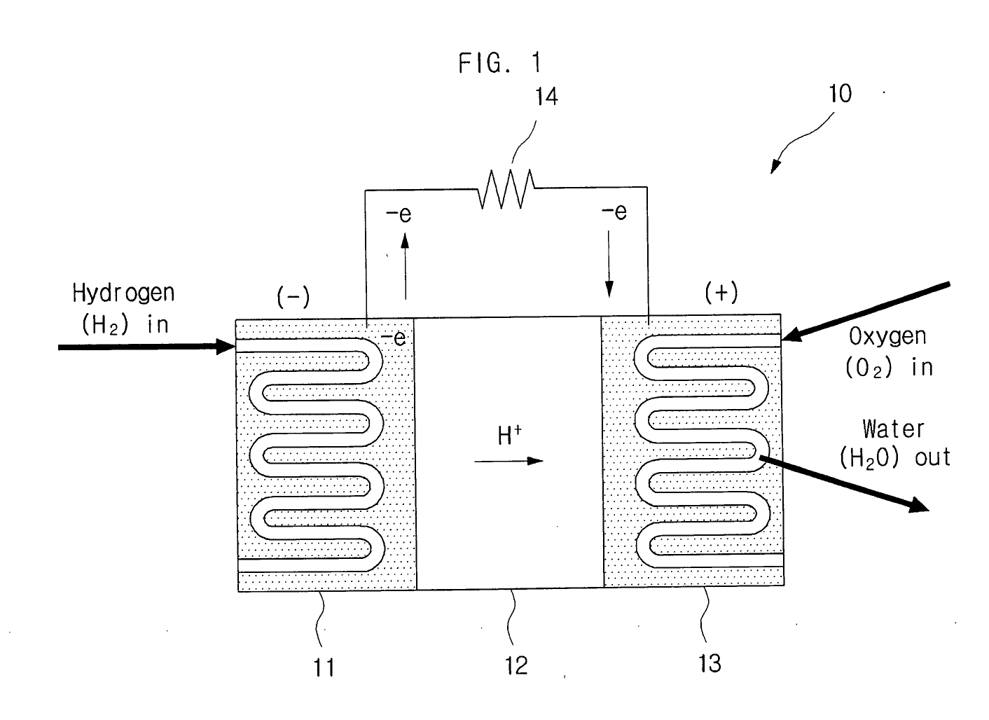

FIG. 2 is a sectional view of a hydrogen generating apparatus according to an example of the present invention.

FIG. 3 is a graph showing a hydrogen generation lasting time according to an example and a comparative example of the present invention.

### DETAILED DESCRIPTION OF THE INVENTION

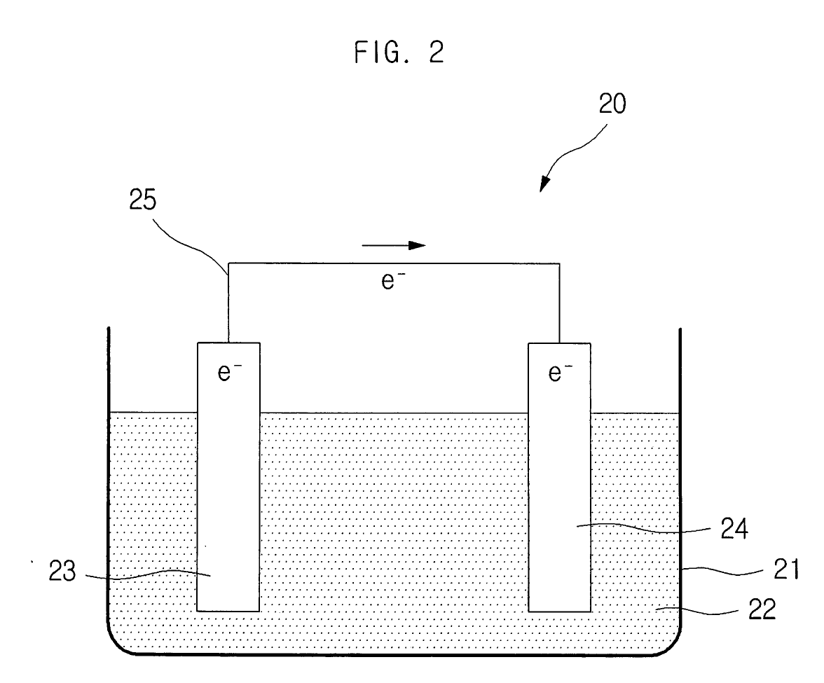

FIG. 2 is a sectional view of a hydrogen generating apparatus according to an example of the present invention. The hydrogen generating apparatus 20 of the present invention includes an electrolyzer 21, a first electrode 23, and a second electrode 24.

The description below focuses on an exemplary case where the first electrode 23 is composed of magnesium (Mg) and the second electrode 24 is composed of stainless steel.

Referring back to FIG. 2, the electrolyzer 21 is filled with an electrolyte solution 22. The electrolyzer 21 can include the first electrode 23 and the second electrode 24, which may be immersed in the electrolyte solution entirely or partly.

The first electrode 23 is an active electrode, where the magnesium (Mg) is oxidized into a magnesium ion (Mg²⁺) releasing two electrons, due to the difference of ionization energy between the magnesium and the water (H₂O). The resulting electrons move to the second electrode 24 through an electric wire 25.

The second electrode 24 is an inactive electrode, where the water molecules receive the electrons moved from the first electrode 23 and is decomposed into hydrogen molecules.

The following Reaction Scheme 2 explains the above mentioned chemical reactions:

First electrode 23: Mg→Mg²⁺+2e⁻

Second electrode 24: 2H₂0+2e⁻→H₂+2(OH)⁻

Overall reaction: Mg+2H₂O→Mg(OH)₂+H₂ [Reaction Scheme 2]

As the above-mentioned hydrogen generation reaction is carried out, the water in the electrolyzer could be overflowed due to a rapid increase in hydrogen flow rate. So, it may require controlling the hydrogen generation rate.

Besides as a result of the Reaction Scheme 2, the magnesium hydroxide (Mg(OH)₂) is produced of which water solubility is no more than about 12 mg/L. So, the magnesium hydroxide exists in a slurry state in the electrolyzer when the reaction is carried out continuously. The magnesium hydroxide slurry, thus, inhibits water movement, which may result in deterioration of efficient hydrogen generation.

An electrolyte solution for the hydrogen generating apparatus of the present invention can include at least one ionizing compound and/or at least one chelating agent to control the hydrogen generation rate and to inhibit production of the magnesium hydroxide.

The ionizing compound included in the electrolyte solution of the present invention increases a conductivity of the electrolyte solution. The ionizing compound including, but not limited to, lithium chloride, potassium chloride, sodium chloride, calcium chloride, potassium nitrate, sodium nitrate, potassium sulfate, sodium sulfate, and mixtures thereof, can be used. Among them, potassium chloride may be more preferably used.

A concentration of the ionizing compound in accordance with the invention may range from about 5 weight % to about 35 weight %, and for example, may range from 10 weight % to 30 weight %. If the concentration of the ionizing compound is less than 5 weight %, the conductivity of the electrolyte solution does not increase sufficiently. On the other hand, if the ionizing compound exceeds 35 weight %, a rapid increase of hydrogen production occurred in the electrolyzer, or an amount of the ionizing compound exceeds water solubility so that the compound remains as a solid state in the electrolyte solution.

The chelating agent combines with the magnesium ion (Mg²⁺) generated in the first electrode 23 to form a water-soluble chelating compound. Such a reaction of the chelating agent with the magnesium ions reduces an amount of the magnesium hydroxide so that hydrogen generation efficiency may not be dropped rapidly.

The chelating agent of the invention may be a carboxylate. The carboxylate including, but not limited to, potassium citrate, sodium citrate, sodium acetate, potassium acetate, ammonium acetate and mixtures thereof can be used.

The following Reaction Scheme 3 explains the combination reaction between the sodium citrate and the magnesium ion to form the water-soluble chelating compound:

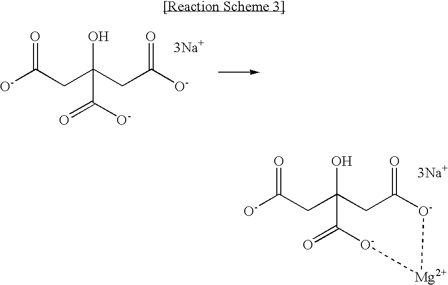

The Reaction Scheme 3 shows that the water-soluble chelating compound is formed by the reaction of the magnesium ion with sodium citrate before the magnesium ion is precipitated as a magnesium hydroxide in the electrolyte solution. Therefore, the chelating agent reduces the magnesium hydroxide formation, which inhibits hydrogen generation, and increases the hydrogen generation efficiency.

The electrolyte solution containing the water soluble chelating compound has a pH 7˜9, so that the magnesium electrode is free from corrosion. Therefore, the electrolyte solution containing the chelating compound increases the hydrogen generation efficiency as well as stable production of hydrogen.

A concentration of the chelating agent in accordance with the invention may range from about 5 weight % to about 20 weight %. If the concentration of the chelating agent is less than 5 weight % or exceeds 20 weight %, ion mobility in the electrolyte solution can be reduced.

A hydrogen generating apparatus not using the chelating agent and/or the ionizing compound has a problem that water in a reactor overflows due to a rapid increase of the hydrogen flow rate. The chelating agent and/or the ionizing compound play a role in controlling of the hydrogen generation rate.

In another aspect, the present invention can provide a hydrogen generating apparatus including an electrolyzer filled with an electrolyte solution including the ionizing compound and the chelating agent described above. Particularly, it includes an electrolyzer filled with an electrolyte solution having water, at least one ionizing compound, and at least one chelating agent; a first metal electrode that is disposed in the electrolyzer, is immersed in the electrolyte solution, and generates electrons; and a second metal electrode that is disposed in the electrolyzer, is immersed in the electrolyte solution, and generates hydrogen gas by receiving the electrons.

In an embodiment of the present invention, the first electrode 23 can be composed of a metal with relatively a high ionization tendency such as iron (Fe) or an alkali metal such as aluminum (Al), zinc (Zn), etc, besides the magnesium. And, the second electrode 24 can be composed of a metal with relatively a lower ionization tendency, compared to the first electrode 23, such as platinum (Pt), copper (Cu), gold (Au), silver (Ag), iron (Fe), etc, besides the stainless steel.

The hydrogen generating apparatus of the present invention may include at least 2 of the first electrode 23 and/or the second electrode 24 independently. As the numbers of the first electrode 23 and/or the second electrode 24 are increased, the amount of the hydrogen generated during the same time becomes larger so that it can take a shorter time to generate the hydrogen as much as demanded.

The hydrogen generating apparatus can be combined with a fuel cell to supply hydrogen to the fuel cell. The fuel cell of the invention is, but not limited to, a polymer membrane fuel cell such as the polymer electrolyte membrane fuel cell.

Also, the hydrogen generating apparatus according to the invention can be used in a fuel cell system including a membrane electrode assembly (MEA) that is provided with hydrogen generated from the hydrogen generating apparatus and produces direct electric current by converting a chemical energy of the hydrogen into an electric energy.

The invention may be better understood by reference to the following examples which are intended for the purpose of illustration and are not to be construed as in any way limiting the scope of the present invention, which is defined in the claims appended hereto.

### EXAMPLE

The hydrogen generation apparatus of generating 40 cc/min hydrogen according to this invention was prepared with the following conditions:

First electrode 23: 3 g of Magnesium (Mg)

Second electrode 24: Stainless steel

Distance between the electrodes: 0.5 mm

Number of used electrodes: 3 Magnesium electrodes, 3 Stainless steel electrodes

Electrode connecting method: Serial connection

Volume of aqueous electrolyte solution: 20 cc

Size of an electrode: 40 mm×60 mm×1 mm,

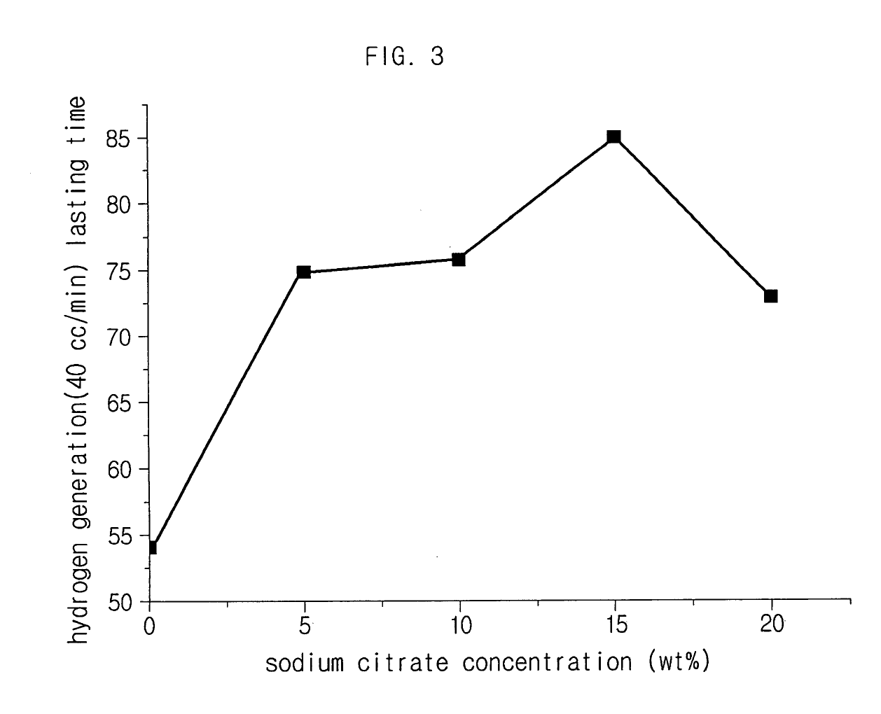

and potassium chloride and sodium citrate were added to the hydrogen generation apparatus as shown in Table 1 and the electrochemical reaction was accomplished. Then, the resulting amount of hydrogen generated was measured by a mass flow meter (MFM) and hydrogen generation (40 cc/min) lasting time (min) was measured. The result is shown in Table 1 and FIG. 3.

TABLE 1

| | | Potassium | Sodium | Hydrogen Generation |
|---|---|---|---|---|
| | | Chloride | Citrate | (40 cc/min) |
| Catagory | | (wt. %) | (wt. %) | Lasting Time (min) |
| Example | 1 | 30 | 5 | 75 |
| | 2 | 30 | 10 | 76 |
| | 3 | 30 | 15 | 85 |
| | 4 | 30 | 20 | 73 |

| | | | |
|---|---|---|---|
| Comparative | 30 | — | 54 |
| Example | | | |

As shown in Table 1 and FIG. 3, it is noted that the electrolyte solution containing the ionizing compound and the chelating agent as in Examples 1-4, time and amount of the hydrogen generation were increased, compared with the Comparative Example.

The present invention can be easily carried out by an ordinary skilled person in the art. Many modifications and changes may be deemed to be with the scope of the present invention as defined in the following claims.

What is claimed is:

1. An electrolyte solution for a hydrogen generating apparatus comprising:
water;
at least one ionizing compound; and
at least one chelating agent.

2. The electrolyte solution for hydrogen generating apparatus according to claim 1, wherein the ionizing compound is selected from the group consisting of lithium chloride, potassium chloride, sodium chloride, calcium chloride, potassium nitrate, sodium nitrate, potassium sulfate, sodium sulfate, and mixtures thereof.

3. The electrolyte solution for hydrogen generating apparatus according to claim 1, wherein the ionizing compound has a concentration ranging from about 5 weight % to about 35 weight %.

4. The electrolyte solution for hydrogen generating apparatus according to claim 1, wherein the chelating agent is a carboxylate.

5. The electrolyte solution for hydrogen generating apparatus according to claim 4, wherein the carboxylate is selected from the group consisting of potassium citrate, sodium citrate, sodium acetate, potassium acetate, ammonium acetate and mixtures thereof.

6. The electrolyte solution for hydrogen generating apparatus according to claim 1, wherein the chelating agent has a concentration ranging from about 5 weight % to about 20 weight %.

7. A hydrogen generating apparatus comprising:
an electrolyzer filled with an electrolyte solution comprising water, at least one ionizing compound, and at least one chelating agent;
a first metal electrode that is disposed in the electrolyzer, is immersed in the electrolyte solution, and generates electrons; and
a second metal electrode that is disposed in the electrolyzer, is immersed in the electrolyte solution, and generates hydrogen gas by receiving the electrons.

8. The hydrogen generating apparatus according to claim 7, wherein the ionizing compound is selected from the group consisting of lithium chloride, potassium chloride, sodium chloride, calcium chloride, potassium nitrate, sodium nitrate, potassium sulfate, sodium sulfate, and mixtures thereof.

9. The hydrogen generating apparatus according to claim 7, wherein the ionizing compound has a concentration ranging from about 5 weight % to about 35 weight %.

10. The hydrogen generating apparatus according to claim 7, wherein the chelating agent is a carboxylate.

11. The hydrogen generating apparatus according to claim 10, wherein the carboxylate is selected from the group consisting of potassium citrate, sodium citrate, sodium acetate, potassium acetate, ammonium acetate and mixtures thereof.

12. The hydrogen generating apparatus according to claim 7, wherein the chelating agent has a concentration ranging from about 5 weight % to about 20 weight %.

13. The hydrogen generating apparatus according to claim 7, wherein the first metal electrode is composed with magnesium.

14. The hydrogen generating apparatus of claim 7, wherein the hydrogen generating apparatus is combined with a fuel cell to supply hydrogen to the fuel cell.

15. The hydrogen generating apparatus of claim 7, wherein at least two of each of the first metal electrode and the second metal electrode are disposed in the electrolyzer.

16. A fuel cell system comprising:
a hydrogen generating apparatus of claim 7; and
a membrane electrode assembly (MEA) that is provided with hydrogen generated from the hydrogen generating apparatus and produces direct electric current by converting a chemical energy of the hydrogen into an electric energy.
